(19) United States
(12) Patent Application Publication
(10) Pub. No.: US 2006/0085264 A1
(43) Pub. Date: Apr. 20, 2006

(54) Restaurant and restaurant building

(76) Inventor: Wesley J. Forehand JR., Portland, TX (US)

Correspondence Address: G. TURNER MOLLER, JR., 711 NORTH CARANCAHUA, SUITE 720, CORPUS CHRISTI, TX, 78475, US

(21) Appl. No.: 10/929,967

(22) Filed: Aug. 30, 2004

(51) Int. Cl. G06Q 30/00

(52) U.S. Cl. 705/15

(57) ABSTRACT

A restaurant receives orders from customers for a variety of different foods. Rather than preparing the foods itself, the restaurant relies of a series of specialty type restaurants to provide the food. The food is prepared and individually packaged by the specialty restaurants. The food is collected from the specialty restaurants and the orders are filled by separating the various foods from the specialty restaurants and amalgamating the foods to correspond to the order. The food orders are delivered to the customers of the restaurant either when the customers appear at the counter or at the drive through window or by delivering the food order to the customer's home or business. The restaurant building includes a dining room but no kitchen or kitchen facilities.

This invention relates to a restaurant and a restaurant building providing a new and unusual technique for delivering food to customers.

### BACKGROUND OF THE INVENTION

There are many restaurant concepts currently being operated in the United States. Many of these concepts are fast food in nature where a sizeable fraction of business is conducted through a drive through window or by delivery where the restaurant delivers food to the home or office of its customers. These type restaurants usually, but not universally, concentrate on one type of food, which is typically fried chicken, pizza, hamburgers and the like, but which may be supplemented by menu items that cater to a different age or style customer. These restaurants are typically large organizations where a franchiser has licensed or franchised its operation to local owner/operators. Those familiar with the United States will recognize this description to be typical of McDONALDS, WENDYS, KENTUCKY FRIED CHICKEN, POPEYES, PIZZA HUT, BURGER KING, TACO BELL, WHATABURGER and many others. These organizations have developed a large customer base familiar with their products and services.

When an order arrives at a typical prior art restaurant of this type, by whatever means, either by telephone, computer, in person or through the drive through window, the order is sent to the kitchen where the food is prepared. After the food is prepared, it is packaged and delivered to the customer, either over the counter, through the drive through window or is delivered to the customer's home or office by an employee or contractor of the restaurant.

Disclosures of some interest relative to this invention are found in U.S. Pat. Nos. 4,797,818; 5,636,710; 5,638,646; 5,720,363; 5,816,443; 6,473,739 and Printed Application 2002/0013730A1.

### SUMMARY OF THE INVENTION

In this invention, a restaurant is preferably located adjacent a major highway because it is anticipated that considerable business will come from travelers who place orders by telephone or other wireless communication technology. Anyone who has travelled with a group of people is aware of the often diverse food requests of passengers. The same is true of many families where there is a wide divergence between what various children want to eat, what parents want to eat and what parents want children to eat. In the practice of this invention, a wide variety of food is made available—more than is available from any one restaurant because the restaurant of this invention obtains food from a variety of participating restaurants that specialize in different type foods.

Arrangements are made with other restaurants, typically known as fast food establishments, so that many different types of food may be delivered to customers. For example, a group of travelers might want a pizza, a hamburger, fried chicken, and a burrito. When the order is received at the restaurant of this invention, the order is retransmitted to the participating restaurants who actually prepare the food. In other words, the pizza order is sent to a pizzeria, the hamburger is sent to a hamburger specialist and so on. Because orders arrive at the restaurant of this invention by telephone or other communication network, payment is preferably obtained by credit card at the time the order is placed.

When the food is prepared, it is packaged by the participating restaurant and delivered to the restaurant of this invention. Perhaps several orders from the participating restaurants are delivered at the same time, meaning that the packaged food must be separated and then amalgamated to correspond to the customer's wishes. The completed orders are then delivered, either to the customer who appears at the restaurant of this invention or is delivered by suitable delivery personnel to the customer's home or office.

For those customers who appear at the restaurant of this invention, the already packaged food may be delivered over the counter or at a drive through window. For customers who wish to eat at the establishment of this invention, a dining room is provided. Those skilled in the art will recognize that the restaurant building of this invention is highly unusual because it has a dining room but no kitchen or kitchen facilities which is here defined to mean a place or equipment where food is cooked or where cooked bulk food is dished out.

It is an object of this invention to provide an improved restaurant and restaurant concept.

A further object of this invention is to provide an unusual restaurant building having a dining room but no kitchen or kitchen facilities.

A more specific object of this invention is to provide an improved restaurant concept that accepts orders for a variety of foods, obtains packaged food from a plurality of participating restaurants and then amalgamates the food to correspond to the customer's order.

These and other objects and advantages of this invention will become more apparent as this description proceeds, reference being made to the accompanying drawings and appended claims.

### BRIEF DESCRIPTION OF THE DRAWINGS

FIG. 1 is an aerial view of a typical restaurant of this invention;

FIG. 2 is a plan view of a typical restaurant building of this invention; and

FIG. 3 is a view of a billboard of a type advertising the restaurant of this invention.

### DETAILED DESCRIPTION

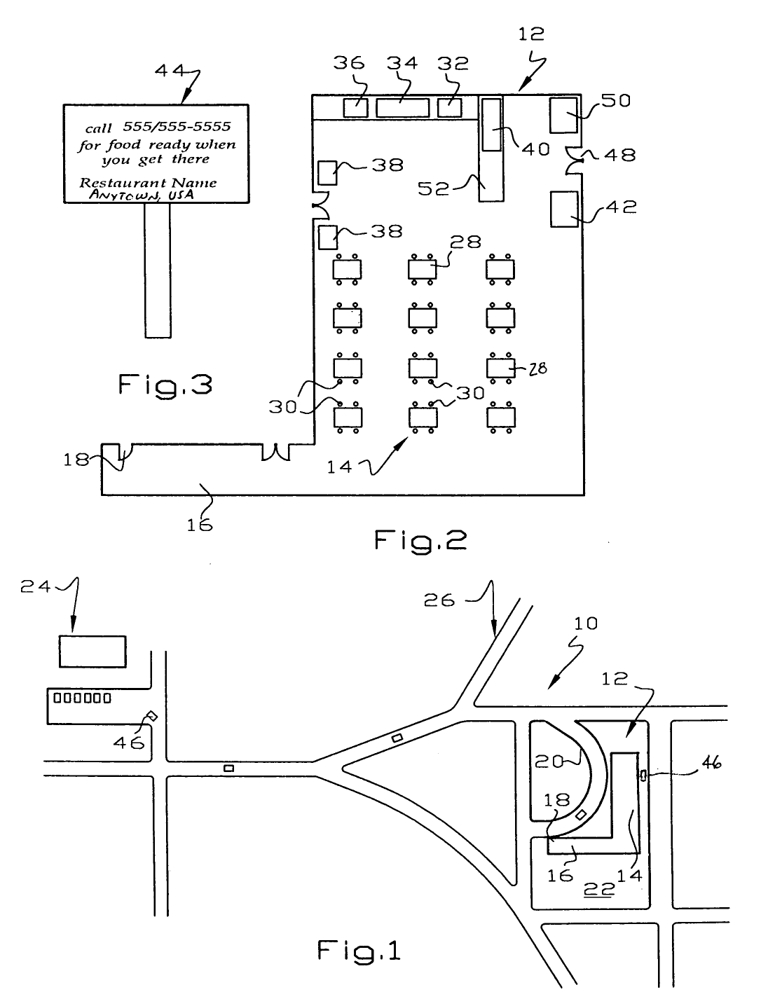

Referring to FIGS. 1-3, there is illustrated a typical restaurant 10 of this invention comprising an enclosed air conditioned building 12 having a dining room 14 and a wing 16 providing a drive through window 18, a driveway 20 leading to the drive through window 18, a parking lot 22 and an outbuilding 24 for drivers and delivery personnel. The restaurant building 12 of this invention is located adjacent a major highway 26 over which a sizeable fraction of business is travelling.

The dining room 14 is, in some respects, wholly conventional providing a series of horizontal eating surfaces 28 such as tables adjacent a series of seats or chairs 30, a condiment station 32, drink dispenser 34, a utensil tray 36, trash receptacles 38 adjacent a front door, a station 40 for warming or reheating foods, a refrigerator and/or freezer 42 and the like. The station 40 may comprise a heat lamp, a steam table, a microwave or other suitable devices. Because all, or a vast majority, of the food served in the building 12 comes packaged from other vendors, usually participating restaurants, the dining room 14 has no kitchen or kitchen facilities, by which is meant a place or equipment where food is cooked or where cooked bulk food is dished out.

Referring to FIG. 3, there is illustrated a billboard 44 located within sight of the highway 26 at a considerable distance from the restaurant building 14, typically at least twenty minutes drive time and preferably in the range of twenty to forty minutes drive time. The billboard 44 urges prospective customers to telephone a number, preferably a toll free number, placing an order for food and providing the message that the food will be ready by the time the customer arrives. In addition, the billboard 44 may advertise a website so prospective customers may use a wireless internet device to place food orders. The billboard 44 may also advertise the type foods provided by the restaurant 10 of this invention and, with their permission, may incorporate the logos of the participating restaurants.

The functions of the outbuilding 24 may be incorporated into the restaurant building 12 or may be in separate buildings as shown in FIG. 1. These functions include receiving orders from customers over a communications network, sending orders to participating restaurants, collecting food from participating restaurants, separating food received from participating restaurants and amalgamating food to correspond to the order and then delivering the food orders to the building 12. It will accordingly be seen that the operation of this invention may be conducted without the dining room 14 but not without the functions of the outbuilding 24.

The delivery vehicles 46 may be of any suitable type and may either be all of one type or of different types, depending on their function. For example, some vehicles may be for local delivery only and thus may not be capable of high speed travel on interstate type highways. Appropriate vehicles will include heating systems for keeping hot foods hot, cooling systems for keeping cold foods cold and freezer systems for keeping frozen foods frozen.

When a customer telephones, or sends an order by other wireless communication devices, an order to the restaurant 10, the order is separated into the types of food ordered and the order is retransmitted to the participating restaurants in accordance with their specialty. In other words, pizza orders are sent to a pizzeria, hamburger orders are sent to a hamburger specialist and the like. Because orders come by communication networks, payment is preferably obtained at the time of the order by use of a credit card.

At or about the time the food orders are ready at the participating restaurants, delivery vehicles 46 are dispatched from the outbuilding 24 to pick up the prepared packaged foods. By packaged foods, it is meant that the food is packaged in the normal manner that fast food restaurants package food. In other words, a pizza is in a pizza box, hamburgers are wrapped in a paper wrapping and then placed in a paper bag, fried chicken is in a paper box and the like.

When the delivery vehicles 46 arrive at the building 12, food from the participating restaurants is passed into the restaurant building 12 in any suitable manner, as through a delivery window 48. The packaged foods are separated, if necessary, and then reassembled or amalgamated to correspond to customer orders. For this purpose, a suitable table or workspace 50 is provided. Thus, if the customer had ordered a pizza, a hamburger and fried chicken, the orders picked up from the participating restaurant would be separated and then reassembled to match the order placed by the customer.

The food orders may be delivered to the customer in a variety of ways. The customer may pick the order up inside the building 12 at a counter 52, or through the drive through window 18 or the food may be delivered to the customer at their home or business by the delivery vehicles 46. Customers picking up food at the counter 52 may take advantage of the dining room 14 and eat their meals in the building 12.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A restaurant providing a dining room and free of facilities to cook food and to dish out prepared bulk food.

2. The restaurant of claim 1 wherein the dining room provides a series of horizontal eating surfaces and a plurality of seats adjacent the horizontal eating surfaces.

3. The restaurant of claim 2 wherein the dining room provides eating utensils, condiments and napkins.

4. The restaurant of claim 1 wherein the dining room provides warmers for keeping hot food warm.

5. The restaurant of claim 1 wherein the dining room provides microwave ovens for reheating food.

6. The restaurant of claim 1 wherein the restaurant provides communication facilities for receiving food orders from customers.

7. The restaurant of claim 6 wherein the restaurant provides communication facilities for ordering food from other restaurants.

8. The restaurant of claim 1 wherein the restaurant is located on a highway and further comprising a billboard on the highway at least twenty minutes travel time from the restaurant, the billboard having the telephone number of the restaurant and a message urging customers to call and place an order for food.

9. A method of ordering and delivering food to customers comprising
receiving an order from a customer for a variety of different type foods;
sending orders to different restaurants that provide each of the different type foods;
collecting the different type foods from the different restaurants;
amalgamating the different type foods from the different restaurants to correspond to the order; and
delivering the order to the customer.

10. The method of claim 9 wherein the orders received from the customer are received over a communication network.

11. The method of claim 9 wherein the different type foods collected from the different restaurants are individually packaged.

12. The method of claim 11 wherein amalgamating step comprises separating the individually packaged foods from the different restaurants and reassembling the packaged foods to correspond to the customer's order.
